(19) United States
(12) Patent Application Publication
(10) Pub. No.: US 2026/0027664 A1
(43) Pub. Date: Jan. 29, 2026

(54) METHOD FOR PERFORMING A MAINTENANCE OR REPAIR OF A ROTOR BLADE OF A WIND TURBINE

(71) Applicant: LM Wind Power A/S, Kolding (DK)

(72) Inventors: Gary Anthony MILLER, Kolding (DK); Raju Dommaraju VENKATARAMANA, Schenectady, NY (US); Arpit JAIN, Schenectady, NY (US); Sudhakar PIRAGALATHALWAR, Bangalore (IN)

(21) Appl. No.: 18/998,753

(22) PCT Filed: Jul. 28, 2023
(86) PCT No.: PCT/EP2023/071045

§ 371 Date: Jan. 27, 2025

(30) Foreign Application Priority Data
Jul. 28, 2022 (EP) 22187588.3

(51) Int. Cl. B23P 6/00; G06N 5/022

(52) U.S. Cl. CPC B23P 6/002; G06N 5/022

(57) ABSTRACT

A method for performing a maintenance or repair of a rotor blade of a wind turbine, the method comprising: planning and scheduling data acquisition; acquiring data of the at least one rotor blade based on the planning and scheduling; processing and analyzing the acquired data using artificial intelligence; identifying (108) defects of the one rotor; and tracking and visualizing the identified defects of the rotor blade; performing a maintenance or a repair of the rotor blade; wherein processing and analyzing the acquired data using artificial intelligence includes determining one or more artificial intelligence, and wherein the artificial intelligence is trained based on previously acquired data of one or more rotor blades and the previously acquired data is further augmented using blending to obtain augmented training data, and wherein the blending includes a random cut and paste and/or a Poisson blending/alpha blending and/or a GAN based blending.

### TECHNICAL FIELD

### Background

Inspections of a wind turbine are typically performed manually by human inspectors that visually inspect in particular the rotor blades of the wind turbine.

A manual inspection by a human inspector is tedious and repetitive and requires specialized experts.

There is therefore a need to improve a maintenance or repair of a rotor blade of a wind turbine, avoiding or reducing the need to employ a specialized human expert and/or supporting the human expert providing artificial intelligence.

### Summary

The invention is defined by the independent claims. The dependent claims define further embodiments of the invention.

According to an aspect, a method is provided for performing a maintenance or repair of a rotor blade of a wind turbine, the method comprising:
planning and scheduling data acquisition, the data comprising data of the at least one rotor blade of the wind turbine;
acquiring data of the at least one rotor blade based on the planning and scheduling;
processing and analyzing the acquired data using artificial intelligence to obtain analyzed data of the at least one rotor blade;
identifying defects of the at least one rotor blade based on the analyzed data of the at least one rotor blade;
tracking and visualizing the identified defects of the at least one rotor blade; and
performing a maintenance or a repair of the at least one rotor blade based on the tracked and visualized identified defects of the at least one rotor blade;
   wherein processing and analyzing the acquired data using artificial intelligence includes determining one or more artificial intelligence algorithms based on one or more types of data in the acquired data, wherein the one or more artificial intelligence algorithms form at least one pipeline determined based on the one or more types of data in the acquired data;
   and wherein the artificial intelligence is trained based on previously acquired data of one or more rotor blades of the same or similar type and the previously acquired data is further augmented using blending to obtain augmented training data for training the artificial intelligence, wherein the blending superimposes images of rotor blade faults with images of rotor blades to obtain augmented faulty images for the training of the artificial intelligence;
   and wherein the blending includes a random cut and paste and/or a Poisson blending/alpha blending and/or a Generative Adversarial Network based blending.

According to another aspect, the present disclosure provides a computer program comprising instructions which, when the program is executed by a computer, cause the computer to carry out the methods of the present disclosure.

According to another aspect, the present disclosure provides a computer readable medium comprising instructions which, when executed by a computer, cause the computer to carry out the methods of the present disclosure.

Aspects and advantages of the present disclosure will be described in detail in the following detailed description and claims and drawings that illustrate the present disclosure.

### BRIEF DESCRIPTION OF THE FIGURES

Details of the present disclosure are illustrated in the figures.

FIG. 1 shows a method for performing maintenance or repair of a rotor blade of a wind turbine according to the present disclosure.

FIG. 2A shows an example of image blending according to the present disclosure.

FIG. 2B shows an example of a label generation according to the present disclosure.

### DETAILED DESCRIPTION

Inspections play a very critical role in ensuring a tight quality control and lower cost in inspection processes. Inspections also enable an effective Asset Performance Management (APM) by providing early defect detection capability to repair the parts before these defects result into catastrophic failures, collateral damages, or expensive repairs. Inspections enable continuous learning of Digital Twin models by providing feedback data related to parts condition to improve damage prediction accuracy. Today most of these inspections are performed manually in the field or in the service shops or in the manufacturing facilities by human inspectors. These inspections are generally visual, tedious and repetitive in nature and require specialized domain expertise. This results into longer processing time, and process variability due to human subjectivity. Hundreds of thousands of wind turbine assets may require monitoring and servicing.

There are large number of energy assets and aging energy infrastructure which require routine inspections to maintain high reliability and resiliency. There is significant opportunity to digitize, improve and scale inspection process and augment human inspectors by using visual and thermal cameras and Artificial Intelligence (AI) technologies.

Effective inspection platform integrates AI technology in inspection workflow to reduce manual and tedious inspection tasks to reduce inspection cycle time and improve detection accuracy. It improves quality of inspection data by using AI in image/video acquisition process by providing navigation and positioning guidance to technicians, robots, and drones. AI also improves inspection decision consistency by removing human subjectivity and creating standard work.

In the present disclosure, an inspection platform is described that manages the entire life cycle of wind turbine blade: manufacturing, monitoring, inspection and repair.

The platform may be configured to carry out a method for performing a maintenance or repair of a rotor blade of a wind turbine, according to methods of the present disclosure.

There are several key components of the inspection platform, for example:
Inspection Planning and Scheduling
Data Management
Artificial Intelligent (AI) pipelines for data analytics Defect tracking and visualization

An important requirement for inspection platform is to seamlessly integrate inspection data and decisions with maintenance, repair, and quality workflows for optimal actions to drive business outcomes, e.g., reduce repair cost, reduce parts replacement cost, and improve product quality, etc.

For example, a business workflow integration may include one or more of:
filed engineer workflow
repair workflow
resource scheduling
quality control

Analysis and reporting may include one or more of:
image search
unit level report
fleet level report
defect tracking

Condition Assessment may include one or more of:
defect detection
defect classification
dimensional measurement
defect propagation

Inspection Workflow Management may include one or more of:
recognition
image/video summary
3D mapping
Inspector feedback
Report generation

Inspection Data Management may include one or more of:
Asset model
Data ingestion
Data storage
Image tagging
Data augmentation
Inspection metadata

Inspections provide critical feedback data to design engineers, manufacturing engineers, equipment operations and maintenance (O&M) staff, asset managers, and services staff, to drive continuous improvement in product design, product manufacturing, product reliability, product safety, and product life cycle cost reduction areas. Inspection data acquisition requires significant efforts and cost. Because of above reasons, inspection data is considered gold data. It also enables continuous learning of digital twin models for predictive maintenance. This data is generated by various inspection modalities, e.g., visual camera, thermal cameras, blue light, images from fluorescent penetration inspection (FPI), CT inspection, etc. Depending on the application this data can be streamed automatically from camera system or human technicians are required to perform inspection and collect the data in local hard drive before uploading to cloud platform. Inspection data management require following capabilities.

Asset Model: It defines a hierarchical data structure establishing the relationship between inspected object, asset, asset location/site and the enterprise. By utilizing the asset model data can be stored without duplication and can be managed efficiently.

Data Ingestion: Enables transportation of inspection data from various sources like cameras, documents to the storage medium so that it can be accessed and processed for getting insights from the data.

Data Storage: All the inspection data can be stored in various mediums considering type and usage of inspection data. As an example, image data can be stored in S3 while the processed data can be stored in Relational Database for quick access and analysis and reporting.

Image Tagging: Each image can be tagged with asset, component, timestamp alongside corresponding inspection attributes such as defects and severity so that any point of time historical reports and defect analysis can be done to impact business.

Data Augmentation: To train the deep learning model to detect new defect types that is not seen in original dataset, augmented data can be created from the available dataset by using cropping, scaling, flipping techniques.

Inspection Metadata Management: Inspection meta data such as inspection types, date, instrument, inspector and the inspected asset can be linked with the Asset Model for inspection management system/product.

Novelty: Using asset model, duplication of data in the database is avoided and information retrieval is improved. The platform provides data annotation capabilities that can capture inspector's domain knowledge so that it can be used to train AI algorithms for specific tasks. Finally, it provides the ability to continuous learning. When inspector interacts with data, feedback about the deficiencies of the algorithm is obtained, which can help in improving the algorithm.

Artificial Intelligent (AI) pipelines for data analytics: The novelty of the platform is that it allows to orchestrate custom AI processing pipelines for different data modalities. Based on the data type and modalities, the platform will automatically pick the right AI algorithm and process the data seamlessly and in a scaled manner. For example, IR data is collected in the form of video and so when user upload sabre data, sabre AI pipeline involving sampling keyframes and defect analytics is executed. On the other hand, when pinwheel photography is uploaded, the system automatically executes defect analytics for pinwheel.

The ability is provided to catalog multiple AI algorithms and execute them in a scalable manner. The Ai algorithms may be sub-modularized, so that there are little dependencies while the backend server does the heavy lifting of orchestrating AI and data flow. This allows the execution of different Machine Learning/Deep Learning algorithms without overhead.

The present disclosure leverages blending-based approach to augment neural network training. Blending approach allow to overcome several issues that plague current neural network training, for example:
Lack of large-scale training data
Lack of balanced data for training (class imbalance)
Modeling rare events such as lighting damage, bonding issues, etc.

For blending, several approaches are considered, in particular for example random cut and paste and/or blending using traditional approaches like Poisson blending/alpha blending and/or Generative Adversarial Network (GAN) based blending

Blending allows to create novel training set without the burden of collecting more labeled data. With the small set of labeled dataset, region of interest from one image can be extracted and superimpose on another image through the above mentioned strategies.

One exemplary approach may be Random Cut and Paste: In this approach, methods according to the present disclosure select a defect region (referred to as patch) from source image, select a random image from a set of defect/non-defect image and randomly select a location within that image to paste the patch after performing some image augmentation on the patch. Given that it is known a priori that the pasted patch contains the crack, the new location contains the same defect.

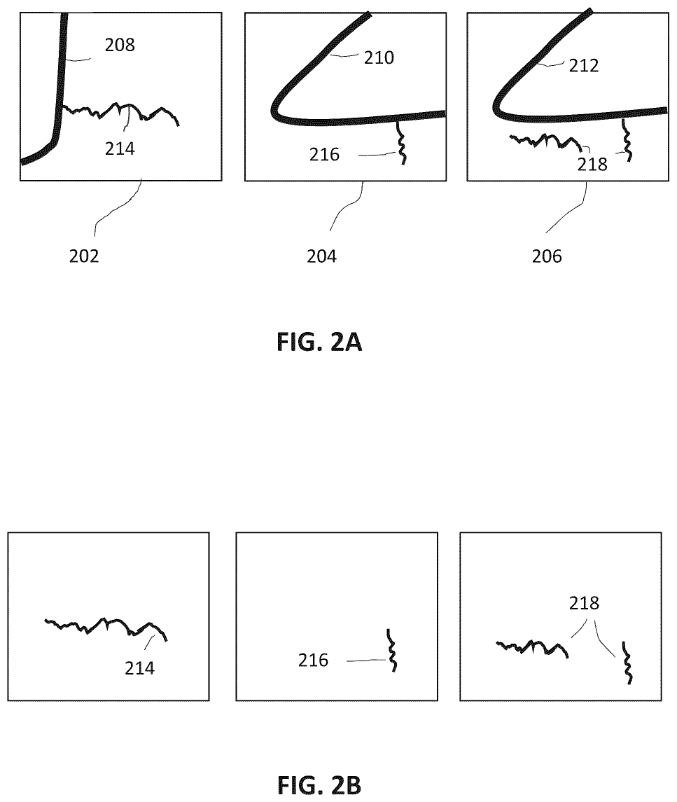

FIG. 2A shows an example of a label generation according to the present disclosure.

A source image 202 is an image including a detail of a rotor blade 208 with a defect region 214.

A target image 204 is another image including a detail of a rotor blade 210 that may or may not include another defect region 216.

The defect region 214 of the source image 202 is identified as a patch that is then pasted/blended on the target image 204 producing the image 206.

When pasting/blending the patch formed by the defect region 214 of the source image 202 onto the target image some image augmentation and/or processing on the patch may be carried out, for example an appropriate scaling.

As a result, an image 206 is obtained that includes the defect 214 in addition to any defect 216 that may be present in the target image 204. In particular the target image 204 may not contain a defect region 216 such that the result image 206 may only include the defect region 214 possibly appropriately transformed.

The result image 206 after pasting/blending then shows a rotor blade 212 (based on the rotor blade 210) including a defect region 218 that includes a (possibly transformed) defect region 214 not originally present in the target image 204.

FIG. 2B shows an example of a label generation according to the present disclosure.

The labels are based on the defect regions 214 and 216. The pasting/blending allows to label the result image 206 with a label based on the defect region 218 that is based on a the defect region 214 of the source image and possibly on the defect region 216 of the target image.

Similar blending can be achieved by using the Generative Adversarial Networks (GANs). One approach to blend a source patch to the target image first generates a low-resolution realistic image and then using the gradient and color constraints generates a higher resolution blended image.

In any classification task involving multiple class categories, there are inter-class variations and intra-class variations. For ex. a crack may look different in different images depending on the width of the crack (intra-class variation). Similarly, a crack may look different from erosion (inter-class variation). One of the observations according to the present disclosure is that during data preparation a crack can be composed of multiple sub-cracks with different appearance properties. A single crack can be divided for example into a plurality of sub-cracks, in particular for example into three sub-cracks.

Using each of these sub-cracks novel samples can be generated using blending and image augmentation. This approach gives a tremendous flexibility in generating new samples. It can also allow to tackle class imbalance problem. For example, the number of crack samples are much smaller than erosion class. Then using blending, many novel crack-blended images to balance the training data for the two classes can be generated.

To identify defects (for example crack), a Convolutional Neural Network (CNN) is trained for segmentation task. A U-Net style architecture with attention layers for training the model can be used.

In this training, any CNN or GANs style architecture designed for segmentation task may be considered. The training architecture takes input as the image and predicts the label of each pixel in the image. Given the ground truth annotation, a loss is computed based on suitable loss function or combination of loss functions (dice loss, cross entropy loss, etc). Finally, layer weights are updated until convergence. During testing, an image is passed through the network to generate the final prediction.

Once defects in images can be identified, the defects over time may be tracked.

Defect tracking and visualization: the ability to track defects over time is extremely critical to take appropriate action to mitigate repair cost and prevent catastrophic failures. In this step, data registration is performed so that defects can be tracked through the entire life cycle. The platform allows to review data between two inspections and compare data to estimate the defect progression. When a defect is tagged, the size of the defect is also measured (for example, using 3D CAD model/using reference length provided automatically or manually). This allows to track the defect growth and estimate the severity based on its category, size, location and impact. The platform also enables visualizing this data (images with defect superimposed) on the screen along with defect progression charts so the inspector can make assessments.

Multiple modalities can be included into a single visualization frame to better estimate the defect threat. There are defects which are better detected in one modality, and the strength of each modality to better categorize the defect and its severity is leveraged. For example, IR imagery can provide assessment of sub-surface defects while visual imagery can provide information about surface defects. All these information and related data can be displayed on the platform for the user. The images of the blade can be stitched together to give the holistic view of the defects w.r.t blades and help in the decisioning related to repair and maintenance.

Another component of visualization is the ability to display multiple modalities (such as color image, thermal image, internal blade data) to the user to better identify and discern the defect.

Automated defect recognition on the multiple modalities can provide additional information to the inspector to perform disposition and have better estimate of defect category and severity from the combined view.

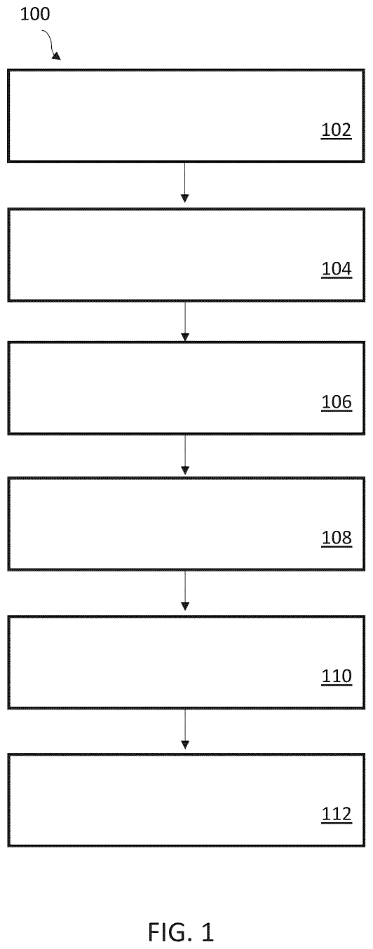

FIG. 1 illustrates a method 100 for performing a maintenance or repair of a rotor blade of a wind turbine, the method comprising:
planning and scheduling 102 data acquisition, the data comprising data of the at least one rotor blade of the wind turbine;
acquiring 104 data of the at least one rotor blade based on the planning and scheduling;
processing and analyzing 106 the acquired data using artificial intelligence to obtain analyzed data of the at least one rotor blade;
identifying 108 defects of the at least one rotor blade based on the analyzed data of the at least one rotor blade;
tracking and visualizing 110 the identified defects of the at least one rotor blade;
performing 112 a maintenance or a repair of the at least one rotor blade based on the tracked and visualized identified defects of the at least one rotor blade.

Processing and analyzing the acquired data using artificial intelligence includes determining one or more artificial intelligence algorithms based on one or more types of data in the acquired data, wherein the one or more artificial intelligence algorithms form at least one pipeline determined based on the one or more types of data in the acquired data; and wherein the artificial intelligence is trained based on previously acquired data of one or more rotor blades of the same or similar type and the previously acquired data is further augmented using blending to obtain augmented training data for training the artificial intelligence, wherein the blending superimposes images of rotor blade faults with images of rotor blades to obtain augmented faulty images for the training of the artificial intelligence;

and wherein the blending includes a random cut and paste and/or a Poisson blending/alpha blending and/or a Generative Adversarial Network based blending.

Defect features may be described by attributes such as for example “shape”, “color”, “texture”, “size”, “area”, “location”, etc. Each defect may be described in terms of these features. A distance can be computed between two features to determine a similarity. If two defects are same or similar, they will share same or similar features attributes.

For example, the attributes such as “shape”, “color”, “texture”, “size”, “area”, may be an attribute function of the position on the rotor blade in a convenient coordinate system of the rotor blade. The function may be restricted to regions where a defect is detected, for example to region where the rotor blade differs from a nominal condition.

Said attribute functions and/or a difference of said attribute functions may then be numerically evaluated with a metric, e.g. a supremum metric or a metric norm in a Lebesgue space. The functions may be scaled, normalized, and/or translated for a better comparison.

Two attribute function describing two attributes for different defects of different rotor blades may be considered similar, if a distance, for example a distance measured with a supremum metric/norm or a Lebesgue metric/norm (a metric norm defined for a Lebesgue space L^{p}) of the two attribute functions is below a threshold. The threshold may be relative to a measure of one of the functions, for example 10% or 15% or 20%.

Therefore, if the difference of the attribute functions describing a corresponding attribute for two defects of two rotor blades has a measure below a predetermined threshold value forming a predetermined deviation threshold value, then the two functions are considered similar.

For example, let Ω be a region in which a defect of a rotor blade is present and let f be a function, that for each point in Ω describes an attribute (that may be a scalar or a vector) like color, texture, position (e.g. of a displacement of the surface of the rotor blade due to the defect), etc.

Then for example a suitable L^{p} norm for measuring f may be

$$‖ f ‖ = {( {\int }_{Ω} {\vert f ( x ) \vert}^{p} dx )}^{1 / p}$$

The value of p may for example be 2.

For comparing two functions f, g that describe a corresponding attribute, said functions may for example be normalized, scaled, translated and then a distance

$$d ( f , g ) = ‖ f - g ‖$$

between the two functions may be evaluated. Said distance may be computed for one or more attributes. A similarity may be assumed if d is below a similarity threshold. The threshold may be a relative threshold (e.g. relative to ∥f∥) of 10% or 15% or 20%.

Alternatively or in addition, the norms ∥f∥ and ∥g∥ and/or an integral of the functions f,g may be compared directly to directly compare an overall measure, like volume, area, height, average color, etc. In said case a similarity may be assumed if ∥f∥−∥g∥ is below a threshold.

For example f,g may measure the height of a surface of a cracked blade for two different defects/blades respectively, for each point in the region of the defect (conveniently scaled, translated, normalized, etc.). Or, alternatively, f,g may be a smoothed measure of said height.

If the distance for one or more attributes of two defects falls below a threshold value, e.g. a relative threshold value in terms of the norm of one of the functions, then the two defects may be considered similar.

An overall distance/metric may be computed. In symbols, let fᵢ,gᵢ be the i-th function attribute for two defects respectively; then a distance dᵢ=∥fᵢ−gᵢ∥ᵢ may be computed for each i, from which an overall distance d may be obtained, e.g. d as the sum d=Σᵢ dᵢ of dᵢ for all i or the d as the square root

$$d = \sqrt{{\sum }_{i} {d}_{i}^{2}}$$

of the sum of the squares of dᵢ. If the overall distance d is below a threshold, a similarity may be assumed.

Therefore, a feature distance d between defect samples allows to determine when defects are of a same or of a similar type.

Rotor blades producing defects of same or similar type are considered rotor blades of same or similar type.

In particular, rotor blades producing defects of same or similar type are rotor blades of same or similar type, and two defects are of same or similar type when a distance between the defects and/or a measure of the defects is within a predetermined threshold value forming a maximal distance and/or an allowable relative deviation of, for example, maximum 10% or 15% or 20%.

For example, processing and analyzing may include training and using a Convolutional Neural Network, for example a U-Net style architecture with attention layers for training the model. In the training, any CNN or GANs style architecture designed for segmentation task may be considered. The training architecture takes as input an image and predicts the label of each pixel in the image. Given the ground truth annotation, a loss is computed based on suitable loss function or combination of loss functions (dice loss, cross entropy loss, etc). Finally, layer weights are updated until convergence. During testing, an image is passed through the network to generate a final prediction. Identifying 108 defects of the at least one rotor blade based on the analyzed data of the at least one rotor blade may be based on the final prediction.

Once defects in images can be identified, the defects over time may be tracked.

In some embodiments, acquiring data of the at least one rotor blade comprises acquiring data with at least one device selected from a visual camera, a thermal camera, a 3D scanner, in particular a blue light 3D scanner and the data is acquired by an automated camera system and/or by a human technician and is stored in a hard drive and/or uploaded to a cloud platform; and/or acquiring data of the at least one rotor blade is based on fluorescent penetrant inspection.

In some embodiments, acquiring data of the at least one rotor blade comprises obtaining data of the at least one rotor blade, organizing the obtained data of the at least one rotor blade into an asset model data structure of the rotor blade to obtain organized acquired data, storing the organized acquired data, tagging the organized acquired data, the method further comprising augmenting the organized data to produce an augmented acquired data set for a training of the artificial intelligence.

To train the artificial intelligence, for example a deep learning model, to detect new defect types that is not seen in original dataset, augmented data may be created from the available dataset by using cropping, scaling, flipping techniques.

In some embodiments, the acquired data further comprises inspection metadata containing information on a performed inspection of the at least one rotor blade, the information including an inspection type and/or an inspection data and/or an inspection instrument and/or an inspector name and/or rotor blade information, in particular serial number, wind turbine number, wind farm, location.

In some embodiments, the artificial intelligence produces the analyzed data of the at least one rotor blade based at least in part on a training of the artificial intelligence based on previously acquired data of one or more rotor blades of the same type and a classification of the previously acquired data of the one or more rotor blades of the same type, in particular the classification is provided by a human inspector and/or is based on ground truth data.

In some embodiments, the artificial intelligence continuously learns based on the interaction of a human inspector that refines a classification of the identified defects.

The processing and analyzing the acquired data using artificial intelligence includes determining one or more artificial intelligence algorithms based on one or more types of data in the acquired data, in particular the one or more artificial intelligence algorithms form at least one pipeline determined based on the one or more types of data in the acquired data.

Custom AI processing pipelines may be considered for different data modalities of the acquired data. Based on the data type and modalities of the acquired data, the platform may automatically pick a suitable AI algorithm and process the data seamlessly and in a scaled manner. For example, IR data is collected in the form of video and so when user uploads sabre data, sabre AI pipeline involving sampling keyframes and defect analytics may be executed. On the other hand, when pinwheel photography is uploaded defect analytics for pinwheel may be executed.

The artificial intelligence is trained based on previously acquired data of one or more rotor blades of the same type and the previously acquired data is further augmented using blending to obtain augmented training data for training the artificial intelligence, in particular the blending superimposes images of rotor blade faults with images of rotor blades to obtain augmented faulty images for the training of the artificial intelligence.

For blending, several approaches may be considered, in particular for example, random cut and paste, blending using traditional approaches like Poisson blending/alpha blending, Generative Adversarial Network (GAN) based blending

Region of interest from one image can be extracted and superimposed on another image through the above mentioned strategies, in particular to train the artificial intelligence.

The blending includes a random cut and paste and/or a Poisson blending/alpha blending and/or a Generative Adversarial Network based blending.

In some embodiments, the blending comprises selecting a random image from a set of images classified as images showing a fault of a rotor blade and superimposing the selected image over an image of a rotor blade of the same or similar type and the artificial intelligence produces labels based on the superimposed image;
and processing and analyzing the acquired data to obtain analyzed data of the at least one rotor blade is based at least in part on labels produced by the trained artificial intelligence.

In some embodiments, the blending comprises a Generative Adversarial Network and processing and analyzing the acquired data using artificial intelligence to obtain analyzed data comprises the training and use of a Convolutional Neural Network.

In some embodiments, tracking and visualizing the identified defects further includes: register data of the identified defects, compare the identified defects with previously identified defects in the same location, track a growth of the identified defects based on the comparison, estimate a severity of the defects.

In some embodiments, tracking and/or visualizing the identified defects comprises visualizing multiple modalities of identified defects and/or analyzed data and/or further comprises visualizing a holistic view of the at least one rotor blade based on a plurality of different images of the identified defects obtained based on different modalities of data acquisition and/or in different time instants.

The present disclosure further provides a computer program comprising instructions which, when the program is executed by a computer, cause the computer to carry out the methods according to the present disclosure.

The present disclosure further provides a computer readable medium comprising instructions which, when executed by a computer, cause the computer to carry out the methods of the present disclosure.

The present disclosure allows the use of artificial intelligence algorithms that are specifically tailored to the type of data that is acquired, providing an optimized pipeline for the specific data type(s), thereby leveraging the mere use of isolated artificial intelligence algorithms into a synergetic pipeline that optimally addresses the process and analysis of the specific type(s) of acquired data.

Not only does the pipeline provide a synergy of artificial intelligence algorithms, but also the training is improved based on the augmented training data obtained using in particular blending techniques.

In particular, the blending and/or the training may be based on previously acquired data of one or more rotor blades of same of similar type, thereby improving the training of the artificial intelligence algorithms that form the pipeline, synergistically increasing the performance of the pipeline.

In fact, the training and/or the blending may be based on previously acquired data of one or more rotor blades of the same or similar type.

For example, a rotor blade with minor differences in size and/or material composition with respect to a given rotor blade may form a rotor blade of a similar type of the given rotor blade. The present disclosure accordingly allows a training of the artificial intelligence algorithms forming the pipeline based on data for example of already existing rotor blades and then to use the artificial intelligence algorithm(s) in the pipeline to process and analyze acquired data of for example a newly obtained/developed/deployed rotor blade with some geometrical and/or material differences to the already existing rotor blades, i.e. of a rotor blade of similar type.

In particular, for example, the training based on previously acquired data of rotor blades of the same or similar type may use blending to superimpose for example images of rotor blades faults in a rotor of similar type, i.e. with slight changes in size and/or material composition, onto images of an actual rotor blade type to boost the performance of the artificial intelligence for the (newer) actual rotor blade without the need of a complete and lengthy retraining, i.e. conveniently reusing the previously acquired data of e.g. the rotor blades with similar type for example during blending.

Therefore, an advantageous synergy is obtained that provides a pipeline of artificial intelligence algorithm(s) specifically associated to the data type(s) without the need of extensive retraining due to a leveraging of existing data obtained e.g. for rotor blades of a similar type using blending techniques.

1-12. (canceled)

13. A method for performing a maintenance or repair of a rotor blade of a wind turbine, the method comprising:
planning and scheduling data acquisition of data of the rotor blade;
acquiring the data of the rotor blade based on the planning and scheduling;
processing and analyzing the acquired data using artificial intelligence to obtain analyzed data of the rotor blade;
identifying defects of the rotor blade based on the analyzed data;
tracking and visualizing the identified defects of the rotor blade;
performing a maintenance or a repair of the rotor blade based on the tracked and visualized identified defects;
the processing and analyzing step comprising determining the artificial intelligence based on type of data in the acquired data such that the artificial intelligence forms a pipeline based on the type of data in the acquired data;
training the artificial intelligence based on previously acquired data of a rotor blade of a same or similar type, and augmenting the previously acquired data using blending to obtain augmented training data for the training, and wherein the blending superimposes images of rotor blade faults with images of rotor blades to obtain augmented faulty images for the training; and
and wherein the blending includes one or more of: a random cut and paste, a Poisson blending, an alpha blending, or a Generative Adversarial Network based blending.

14. The method of claim 13, wherein the acquiring data step comprises one of:
acquiring the data with at least one device selected from: a visual camera, a thermal camera, or a 3D scanner, wherein the data is acquired by an automated camera system or by a human technician and is stored in a hard drive or uploaded to a cloud platform; or
acquiring the data based on fluorescent penetrant inspection.

15. The method of claim 13, wherein the acquiring data step comprises:
organizing the acquired data into an asset model data structure of the rotor blade to obtain organized acquired data;
storing the organized acquired data, and tagging the organized acquired data; and
the method further comprising augmenting the organized acquired data to produce an augmented acquired data set for the training of the artificial intelligence.

16. The method of claim 13, wherein the acquired data further comprises inspection metadata containing information on a performed inspection of the rotor blade, the information including one or more of: an inspection type, an inspection data, an inspection instrument, an inspector name, rotor blade information, wind turbine number, wind farm identification, or wind turbine location.

17. The method of claim 13, wherein the previously acquired data used for training the artificial intelligence is further classified by a human inspector or based on ground truth data.

18. The method of claim 17, wherein the artificial intelligence continuously learns based on interaction of the human inspector that refines a classification of the identified defects.

19. The method of claim 13, wherein the blending comprises selecting a random image from a set of the images or rotor blade faults and superimposing the selected image over an image of the rotor blade of the same or similar type and wherein the artificial intelligence produces labels based on the superimposed image; and
and wherein the processing and analyzing step is based at least in part on labels produced by the trained artificial intelligence.

20. The method of claim 13, wherein the blending comprises a Generative Adversarial Network and wherein the processing and analyzing step comprises use of a Convolutional Neural Network in the training of the artificial intelligence.

21. The method of claim 13, wherein the tracking and visualizing step further comprises: registering data of the identified defects, comparing the identified defects with previously identified defects in the same location, tracking a growth of the identified defects based on the comparison, and estimating a severity of the identified defects.

22. The method of claim 13, wherein the tracking and visualizing step further comprises one or more of:
visualizing multiple modalities of the identified defects or the analyzed data; or
visualizing a holistic view of the rotor blade based on a plurality of different images of the identified defects obtained based on different modalities of data acquisition or in different time instants.

23. A computer program comprising instructions which, when executed by a computer, cause the computer to carry out the method of claim 13

24. A computer readable medium comprising instructions which, when executed by a computer, cause the computer to carry out the method of claim 13.
